(19) United States
(12) Patent Application Publication
(10) Pub. No.: US 2008/0311221 A1
(43) Pub. Date: Dec. 18, 2008

(54) LEWIS ACID AND OIL-SOLUBLE HYBRID PESTICIDE CONCENTRATE THAT SPONTANEOUSLY FORMS A WATER-BASED MICROEMULSION

(75) Inventors: Dale Sanson, Kearney, MO (US); James A. Armbruster, Kansas City, MO (US)

Correspondence Address: HOVEY WILLIAMS LLP, 10801 Mastin Blvd., Suite 1000, Overland Park, KS, 66210, US

(73) Assignee: PBI/Gordon Corporation, Kansas City, MO (US)

(21) Appl. No.: 11/763,038

(22) Filed: Jun. 14, 2007

(51) Int. Cl. A01N 25/04; A01N 37/10; A01N 43/16; A01N 43/40; A01N 43/42; A01N 43/56; A01N 59/26; A01P 15/00

(52) U.S. Cl. 424/605; 514/311; 514/355; 514/407; 514/453; 514/570; 514/772; 514/785

(57) ABSTRACT

A chemically and physically stable, transparent, hybrid pesticide concentrate is provided for preparation of a water-based microemulsion formulation. The pesticides preferably comprise an oil-soluble pesticide component, and a pesticide component having a Lewis acid pesticide portion and a pesticide complex portion. An inactive biphasic coupling agent for the pesticide ingredients includes a solvent capable of solvating the oil-soluble pesticide component, and two organic cosolvents capable of solvating the Lewis acid pesticide portion and the pesticide complex portion pesticide ingredients, respectively. A selected emulsifier is incorporated in the concentrate. A sufficient quantity of a complexing agent is provided to maintain the electrical potential of the final concentrate at a value of about −150 mV to about +150 mV. The inactive coupling agent and the complexing agent are sufficient relative to the quantity of the active pesticide ingredients to cause the concentrate to spontaneously form a microemulsion made up of particles that are less than 1μ when the concentrate is diluted with water.

### BACKGROUND OF THE INVENTION

1. Field of the Invention

A chemically and physically stable pesticide concentrate is provided, containing as many as five and at least two active ingredients, one of which is a Lewis acid and the other of which is oil soluble, that when added to water spontaneously forms a water-based sprayable microemulsion. The concentrate preferably includes as active pesticide ingredients, a Lewis acid pesticide portion, a pesticide complex portion, and an oil-soluble pesticide component. The Lewis acid and pesticide complex portions are normally incompatible with the oil-soluble pesticide component. In order to render the pesticide ingredients of the concentrate compatible with one another, an inactive biphasic coupling agent is provided that includes a solvent capable of solvating the oil-soluble pesticide component, and two organic cosolvents. One of the cosolvents is capable of solvating the Lewis acid portion of the pesticide ingredients. The other cosolvent is capable of solvating the pesticide complex portion of the pesticide ingredients. A complexing agent is provided in the concentrate, which reacts with the Lewis acid portion to form a complex sufficient to maintain the electrical potential level of the concentrate within the range of about −150 mV to about +150 mV.

2. Description of the Prior Art

Pesticidal concentrates have long been provided for dilution by a pesticide applicator. Herbicides, for example, available in oil-based concentrate form, have included products such as 2,4-D, MCPP, and dicamba, and combinations thereof along with an emulsifying agent. Concentrates, used by commercial applicators to form tank mixes that are applied in a timely manner following mixing, avoid the necessity of transporting large volumes of the herbicidal mixture, the vast majority of which is water. Similarly, organic solvent-based concentrates comprised of esters of 2,4-D, MCPA, and dicamba as Lewis acids, individually or in various combinations, in conjunction with an emulsifier have long been used by commercial spray companies.

In U.S. Pat. No. 6,232,272, an oil-soluble phenoxy acid ester pesticide, such as the iso-octyl ester of 2,4-D, is mixed with a methylated soybean oil and an emulsifier. The formulations of the '272 patent are limited to a single pesticide ingredient, which is of the oil-soluble type.

Those Lewis acid pesticides that have been registered are not soluble in water and, even when in water-soluble salt form, cannot be combined with registered oil-soluble pesticides along with conventional emulsifiers, because the concentrate does not have long-term chemical and physical stability, especially at varying temperatures encountered during storage and transportation. It has not previously been feasible to combine a number of water-soluble acid pesticides with labile oil-soluble pesticides because the pH of the combination would be greater than 7. At that pH level, the oil-soluble pesticides would undergo hydrolysis and be unstable in the presence of the inherently hygroscopic emulsifiers required to form an emulsifiable concentrate (EC).

On the other hand, combining an acidic pesticide with an oil-soluble pesticide to form a concentrate has not been practical because available Lewis acid pesticides are not water soluble, and cannot be adequately emulsified in concentrate form for dilution in water at normal use levels.

### SUMMARY OF THE INVENTION

This invention relates to a chemically and physically stable, transparent, hybrid pesticide concentrate that when added to water spontaneously forms a sprayable microemulsion. The concentrate comprises as active pesticide ingredients, from about 0.1% to about 10% by weight of a an oil-soluble pesticide component, and from about 0.1% to about 20% by weight of another pesticide component having a Lewis acid pesticide portion and a pesticide complex portion. An inactive biphasic coupling agent combined with the active ingredients includes from about 5% to about 30% of a solvent capable of solvating the oil-soluble pesticide component, from 2% to preferably about 35%, and more preferably about 32%, of an organic cosolvent capable of solvating the Lewis acid pesticide portion of the other pesticide component, from about 2% to preferably about 35%, and more preferably about 32%, of an organic cosolvent capable of solvating the pesticide complex portion of the other pesticide component. From about 10% to preferably about 25%, and more preferably about 21%, of emulsifier for the pesticide ingredients is also included in the concentrate.

A complexing agent is also included in the concentrate with a sufficient quantity thereof being provided to maintain the electrical potential level of the concentrate at a value of from about −150 mV to about +150 mV. The amount of the inactive biphasic coupling agent and the complexing agent are sufficient relative to the quantity of the active pesticide ingredients to cause the concentrate to spontaneously form a microemulsion made up of particles that are no larger than about 1μ when the concentrate is diluted with water to form either a ready-to-use pesticide formulation (RTU) or a tank mix microemulsion (ME). In preferred formulations, the median size of the particles of the microemulsion are less than about 1μ, and nominally less than about 0.3μ. RTU and ME formulations contain from about 1% to about 10% by weight of concentrate, preferably from about 1% to about 4% by weight of concentrate, and most preferably from about 2% to about 4% by weight of the concentrate in water of dilution.

If a pesticide concentrate was prepared containing a Lewis acid herbicide, a labile oil soluble herbicide, and emulsifiers, the oil soluble herbicide would rapidly degrade in the acidic conditions created by inclusion of the Lewis acid herbicide. Mere incorporation of an additive that decreased the acidity of the concentrate would not protect the concentrate from chemical and physical instability.

It has been discovered that a chemically and physically stable concentrate can be provided that includes both an oil-soluble pesticide component, and a component having a Lewis acid portion and a portion that has complexed with the Lewis acid. The Lewis acid complex portion is produced by adding a sufficient quantity of a complexing agent to the concentrate to only partially complex with the Lewis acid component.

Preferred complexing agents act as Lewis bases which possess an available pair of electrons that are donated to the pesticidal Lewis acid receptor species. Exemplary complexing bases in accordance with this invention include diethanolamine (DEA), triethanolamine (TEA), KOH, or equivalent agents. Complexation occurs as shown:

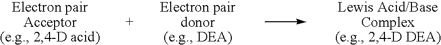

A Lewis acid/base interaction does not occur in an aqueous system, and therefore a pH value cannot be determined. Varying the relative concentrations of the reactive constituents results in complexes having a range of observed millivoltage values. Preferably, an amount of the complexing agent is added that is sufficient to maintain the electrical potential of the concentrate at a level of from about −150 mV to about +150 mV and at a nominal pH of from about 5 to about 6.5, thereby leaving respective portions of Lewis acid and Lewis acid complex that are a function of the quantity of complexing agent added.

The interaction of the biphasic coupling system further assists in the solubilization of the resulting Lewis acid/base complex and the other organic soluble active ingredients. Improper emulsifier selection will result in failure for the formulation (complexes, active ingredients) to spontaneously form a microemulsion when added to water, and resulting in the chemical and physical instability of the oil soluble pesticide.

The selected emulsifier for the pesticide ingredients cooperates with the distinct solvent and cosolvents of the inactive biphasic coupling agent to spontaneously form a microemulsion containing oil soluble, Lewis acid, and complexed pesticide particles that are less than 1μ, and nominally of the order of less than 0.3μ when the concentrate is added to water of dilution.

Examples of useful pesticides in the formulation of the present invention include herbicidal agents, insecticides/antifeedants, and fungicides.

### BRIEF DESCRIPTION OF THE DRAWINGS

FIGS. 1 and 2 are representative mean value graphs of the particle size distribution of samples of preferred microemulsion pesticide formulations containing concentrates of this invention. The samples were each tested using a Horiba LA950 laser scattering particle size distribution analyzer.

### DETAILED DESCRIPTION OF THE PREFERRED EMBODIMENT

The preferred concentrate of this invention for preparing microemulsion pesticide formulations includes active pesticide ingredients comprising from about 0.1% to about 10% by weight of an oil-soluble pesticide component and from about 0.1% to about 20% by weight of a second pesticide component. At least one and preferably a plurality of Lewis acid pesticides are combined with at least one and preferably a number of oil-soluble pesticides. A complexing agent is incorporated in the concentrate to partially neutralize the Lewis acids, resulting in a portion of the second pesticide component remaining in Lewis acid form while the remainder of the initial amount of Lewis acid pesticides is in complexed form. The quantity of complexing agent added is sufficient to maintain the electrical potential of the final concentrate at a value of about −150 mV to about +150 mV, and thereby nominally have a pH within the range of from about 5 to about 6.5.

Exemplary pesticides initially in Lewis acid form that may be incorporated in the concentrate include quinclorac, 2,4-D, fenoxaprop, dikegulac, mefluidide, glyphosate, dicamba, MCPP, MCPA, MCPB, 2,4-DP, triclopyr, picloram, 2,4-DB, fluoroxypyr, aminopyralid, clopyralid, optical isomers of MCPP, MCPB, 2,4-DP, imazaquin, imazethapyr, imazapyr, MSMA, boric acid, and phosphoric acid.

Oil-soluble pesticides may include a protox inhibitor selected from the group consisting of pyraflufen-ethyl, flumiclorac-pentyl, flumioxazin, fluthiacet-methyl, aclonifen, bifenox, chlornitrophen, ethoxyfen, fluoroglycofen-ethyl, fomesafen, lactofen, oxyfluorfen, azafendin, cinidon-ethyl, oxadiargyl, oxadiazon, pentoxazone, flumipropyn, flupropacil, benzfendizone, nipyraclofen, fluazolate, thidiazimin, a triazalone, and a compound having the structural formula

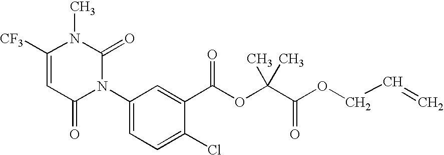

or combinations thereof.

Oil soluble pesticide components are usually selected from the group consisting of dithiopyr, chlorflurenol, fenoxaprop-ethyl, fluazifop-p-butyl, esters of 2,4-D, 2,4-DP, MCPP, MCPB, MCPA, triclopyr, picloram, 2,4-DB, fluoroxypyr, aminopyralid, clopyralid, and the optical isomers of MCPP, MCPB, and 2,4-DP.

Other pesticides having properties and characteristics that are similar to the above oil soluble and Lewis acid pesticides may be used. For example, the pesticide may be an oil soluble insecticide/antifeedant such as commercially available azadirachtin. A usable Lewis Acid fungicide may for example be phosphoric acid.

The complexing agent incorporated in the concentrate, and that is added at a level to maintain the electrical potential of the final concentrate at a value of about −150 mV to about +150 mV, is preferably DEA, but may be TEA, KOH, or equivalent agents.

From about 5% to about 30% by weight of the solvent that has a Hansen solubility value of 20-30 and is capable of solvating the oil-soluble pesticide component is preferably provided. An exemplary solvent is a 3-8 member C₂ to C₂₀ heterocyclic compound containing 1-10 oxygen atoms may include hydroxyl, carboxylic, ketone, and lactone group, with an alkyl carbonate such as propylene carbonate being preferred. Other useful solvents are tetrahydrofuran, dioxane, crown ethers, cyclohexanone, and cyclohexanol.

From about 2% to preferably about 35%, and more preferably about 32%, by weight of an organic cosolvent is provided that is capable of solvating the remaining Lewis acid pesticide portion of the concentrate. Useful cosolvents include linear or branched multi-hydroxylated relatively long chain C₆ to C₁₀ hydrocarbons or olefins containing 2-10 oxygens. An exemplary cosolvent is hexylene glycol.

From about 2% to preferably about 35%, and more preferably about 32%, by weight of an organic cosolvent is provided that is capable of solvating the pesticide complex portion of the concentrate. Useful cosolvents include linear or branched multi-hydroxylated relatively short chain C₃ to C₄ compounds containing 2-10 oxygens. Exemplary cosolvents include propylene glycol, butylene glycol, and glycerol.

The selected emulsifier is preferably a nonionic emulsifier having an HLB value of 10-14, and may comprise a linear alcohol C₉-C₁₄ ethoxylate having 9-30 moles of ethoxylation, an ethoxylated aryl phenol having 9-30 moles of ethoxylation, or alkyl phenol ethoxylates, linear and/or branched fatty acids ethoxylates, hydrocarbon linear and/or branched alcohol ethoxylates, alkoxylated amides, alkoxylated amines, comb block polymers, and ethylene/propylene block polymers. A preferred emulsifier has a molecular formula of C₁₄H₂₂O(C₂H₄O)n corresponding to the structure:

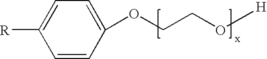

where X=2-30 and R is H or an alkyl group.

A stable pesticide concentrate for preparation of a water-based microemulsion formulation may comprise on a weight percent basis:

### EXAMPLE 1

| Ingredient | Wt (%) |
|---|---|
| Dithiopyr* (93.7%) | 1.62% |
| 2-4,D** (97.9%) | 10.74% |
| Quinclorac** (98.0%) | 4.41% |
| Dicamba** (98.0%) | 1.11% |
| Pyraflufen-ethyl* (92.0%) | 0.45% |
| Propylene Carbonate | 6.12% |
| Hexylene Glycol | 24.49% |
| Glycerol | 24.49% |
| Triton X-100 | 12.15% |
| DEA (98%) | 14.43% |

Five-way active - two oil soluble* pesticides and three initially Lewis acid** pesticides.

A direct electrical potential analysis of the concentrate of Example 1 yielded a value of −104 mV.

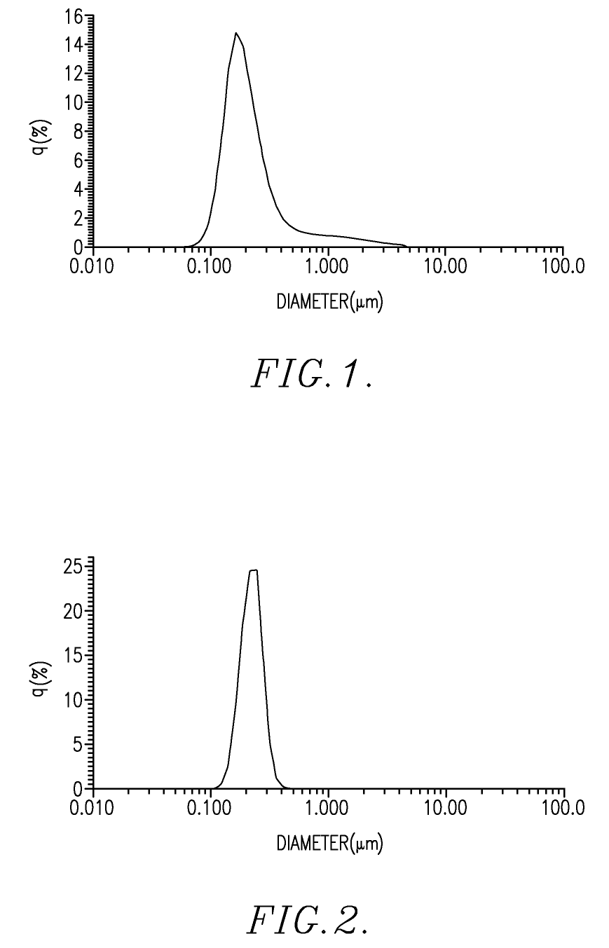

Four percent by weight of the concentrate of Example 1 was diluted with water to form three microemulsion samples. FIG. 1 is a graphical representation of the analyses of the three samples using the Horiba LA 950 particle size distribution analyzer. The median particle size of the three samples was found to be of the order of 0.19μ. The 4% solution of the concentrate of Example 1 in de-ionized water yielded an electrical potential value of −82 mV.

### EXAMPLE 2

| Ingredient | Wt (%) |
|---|---|
| Dithiopyr* (93.7%) | 4.51% |
| 2-4,D** (97.9%) | 10.53% |
| R(+) MCPP** (90.8%) | 5.68% |
| Dicamba** (98.0%) | 1.05% |
| Propylene Carbonate | 6.44% |
| Hexylene Glycol | 25.78% |
| Glycerol | 25.78% |
| Triton X-100 | 11.37% |
| DEA (98%) | 8.87% |

Four-way active - one oil soluble* pesticide and three initially Lewis acid** pesticides.

A direct electrical potential analysis of the concentrate of Example 2 yielded a value of −20 mV.

Two percent by weight of the concentrate of Example 2 was diluted with water to form three microemulsion samples. FIG. 1 is a graphical representation of the analyses of the three samples using the Horiba LA 950 particle size distribution analyzer. The median particle size of the three samples was found to be of the order of 0.2μ. The 2% solution of the concentrate of Example 1 in de-ionized water yielded an electrical potential value of +108 mV.

### EXAMPLE 3

| Ingredient | Wt (%) |
|---|---|
| Chlorflurenol* (93.7%) | 2.75% |
| R(+) MCPP** (97.9%) | 4.38% |
| Propylene Carbonate | 9.61% |
| Hexylene Glycol | 31.63% |
| Glycerol | 31.63% |
| Triton X-100 | 9.62% |
| DEA (98%) | 10.38% |

Two-way active - one oil soluble* pesticide and one initially Lewis acid** pesticide.

A pesticide microemulsion formulation prepared using, for example, the concentrate of Examples 1, 2, or 3 may be prepared by adding from about 1% to about 10% by weight of the concentrate, preferably from about 1% to about 4% by weight of the concentrate, and most preferably from about 2% to about 4% by weight of the concentrate in water of dilution.

### EXAMPLE 4

| Ingredient | Wt (%) |
|---|---|
| Quinclorac** (98.0%) | 2.32% |
| Dithiopyr* (93.7%) | 1.20% |
| Propylene Carbonate | 7.91% |
| Hexylene Glycol | 31.64% |
| Glycerol | 31.64% |
| Triton X-100 | 15.79% |
| DEA (98%) | 9.51% |

Two-way active - one oil soluble* pesticide and one initially Lewis acid** pesticide.

### EXAMPLE 5

| Ingredient | Wt (%) |
|---|---|
| Chlorflurenol* (98.0%) | 2.95% |
| 2-4,D** (97.9%) | 4.35% |
| Propylene Carbonate | 14.73% |
| Hexylene Glycol | 31.48% |
| Glycerol | 31.48% |
| Triton X-100 | 13.39% |
| DEA (98%) | 1.62% |

Two-way active - one oil soluble* pesticide and one initially Lewis acid** pesticide.

### EXAMPLE 6

| Ingredient | Wt (%) |
|---|---|
| Dithiopyr* (91.5%) | 2.16% |
| Sulfentrazone* (92.3%) | 0.40% |
| 2-4,D** (97.9%) | 9.56% |
| Dicamba** (98.0%) | 0.93% |
| Quinclorac** (98.0%) | 1.96% |
| Propylene Carbonate | 7.16% |
| Glycerol | 28.64% |
| Hexylene Glycol | 28.64% |
| Triton X-100 | 12.09% |
| DEA (98%) | 8.45%. |

Five-way active - two oil soluble* pesticides and three initially Lewis acid** pesticides.

### EXAMPLE 7

| Ingredient | Wt (%) |
|---|---|
| Fluazifop-butyl* (92.0%) | 1.59% |
| Mefluidide* (51.0%) | 0.63% |
| Propylene Carbonate | 17.16% |
| Propylene Glycol | 31.46% |
| Hexylene Glycol | 28.60% |
| Triton X-100 | 20.02% |
| DEA (98%) | 0.55%. |

Two-way active - one oil soluble* pesticide and one initially Lewis acid** pesticide.

### EXAMPLE 8

| Ingredient | Wt (%) |
|---|---|
| Azadirachtin* (53%) | 2.91% |
| Phosphoric acid** (45.8%) | 2.93% |
| Propylene Carbonate | 30.45% |
| Propylene Glycol | 16.61% |
| Hexylene Glycol | 27.69% |
| Triton X-100 | 19.38% |
| DEA (98%) | 0.03%. |

Two-way active - an oil soluble* insecticide and an initial Lewis acid** fungicide.

A sample of the concentrate of Example 4 was subjected to three successive stability tests. During each test, the concentrate was prepared and placed in an upright freezer for 12 hours at −15° C. The sample was then removed from the freezer and immediately inspected for evidence of crystallization or precipitation. No evidence of such crystallization or precipitation was found to be present. The temperature of the sample was allowed to rise to room temperature and maintained at that temperature for a period of 12 hours. No evidence of precipitation or crystallization of the sample was observed during or upon termination of the 12-hour ambient temperature test period.

Another sample of the concentrate Example 4 was subjected to a standard accelerated chemical stability test by conducting an HPLC analysis of each of the active ingredients to determine the percent concentration of each active in the concentrate. The sample was then placed in a sealed container and stored at 40° C. for thirty days. An HPLC analysis was repeated following the extended storage period. The results of the accelerated chemical stability test are set forth in Table 1. All are within accepted limits as established by U.S. EPA for pesticidal products.

TABLE 1

| Ingredient | Initial | Final | % Diff |
|---|---|---|---|
| Dicamba | 1.141% | 1.091% | −4.38 |
| 2,4-D | 9.203% | 8.987% | −2.35 |
| Dithiopyr | 1.977% | 1.909% | −3.44 |
| Quinclorac | 1.91% | 1.876% | −1.78 |
| Sulfentrazone | 0.379% | 0.363% | −4.22 |

A further sample of the concentrate of Example 4 was tested under ambient storage conditions at 25° C. for two and one-half months. The sample was initially subjected to an HPLC test, and then again tested at the end of the storage period. The results of this test are set forth in Table 2.

TABLE 2

| Ingredient | Initial | Final | % Diff |
|---|---|---|---|
| Dicamba | 0.946% | 0.933% | −1.37 |
| 2,4-D | 9.203% | 9.154% | −0.53 |
| Dithiopyr | 1.977% | 1.921% | −2.83 |
| Quinclorac | 1.91% | 1.929% | 0.99 |
| Sulfentrazone | 0.379% | 0.380% | 0.26 |

2,4-D herbicidal agents in acid form are of limited efficacy because of the difficulty of the active agent entering through the cuticle of the weeds. For that reason, acidic herbicides such as 2,4-D are conventionally converted to ester form, for example, the ethylhexyl ester. Efficacy tests comparing the ethylhexyl ester of 2,4-D as a conventional emulsifiable concentrate with a 2,4-D acid-chlorflurenol microemulsion prepared in accordance with the present invention, demonstrated that these herbicidal agents have equivalent weed control properties. The results of dollar weed control in turf are set forth in Table 3.

TABLE 3

| | | % Dollar Weed (Pennywort) | | |
|---|---|---|---|---|
| | | Control | | |
| Treatment | Pts/A | 16 DAA¹ | 28 DAA | 42 DAA |
| 0.37 lbs/gal 2,4-D as | 8 | 95.7 | 97.7 | 90.7 |
| 2-EHE² + 0.25 lbs/ | | | | |
| gal chloflurenol | | | | |
| (Emulsifiable Concentrate) | | | | |
| 0.37 lbs/gal 2,4-D + 0.25 lbs/ | 8 | 93.0 | 96.0 | 93.4 |
| gal Chlorflurenol | | | | |
| (Microemulsion) | | | | |

¹DAA = Days After Application.
²EHE = Ethylhexyl Ester

We claim:

1. A chemically and physically stable, transparent, hybrid pesticide concentrate for preparation of a water-based sprayable microemulsion comprising the combination of:
a quantity of active pesticide ingredients that includes from about 0.1% to about 10% by weight of first oil-soluble pesticide component, and from about 0.1% to about 20% by weight of a second pesticide component having a Lewis acid pesticide portion and a pesticide complex portion;
an amount of an inactive biphasic coupling agent for the pesticide ingredients that includes from about 5% to about 30% by weight of a solvent capable of solvating the first oil-soluble pesticide component, from about 2% to about 32% by weight of a first organic cosolvent capable of solvating the Lewis acid pesticide portion of the second pesticide component, from about 2% to about 32% by weight of a second organic cosolvent capable of solvating the pesticide complex portion of the second pesticide component, and from about 10% to about 21% by weight of an emulsifier for the pesticide ingredients; and
a sufficient quantity of a complexing agent for the Lewis acid pesticide portion to maintain the electrical potential level of the concentrate at a value of from about −150 mV to about +150 mV,
the amount of the inactive coupling agent and the complexing agent being sufficient relative to the quantity of the active pesticide ingredients to cause the concentrate to spontaneously form a microemulsion made up of particles that are no larger than about 10μ when the concentrate is diluted with water.

2. A pesticide concentrate as set forth in claim 1, wherein the molar ratio of the complexing agent to the Lewis acid pesticide portion is from about 0.75:1 to about 1.5:1.

3. A pesticide concentrate as set forth in claim 1, wherein said solvent is a heterocyclic compound.

4. A pesticide concentrate as set forth in claim 1, wherein said solvent has a Hansen solubility value of 20-30.

5. A pesticide concentrate as set forth in claim 3, wherein said solvent is a 3-8 membered C₂-C₂₀ heterocyclic compound containing 1-10 oxygen atoms.

6. A pesticide concentrate as set forth in claim 3, wherein said heterocyclic solvent includes linear and branched hydrocarbons.

7. A pesticide concentrate as set forth in claim 3, wherein said heterocyclic solvent includes hydroxyl, carboxylic, ketone, and lactone groups.

8. A pesticide concentrate as set forth in claim 1, wherein said solvent is an alkyl carbonate.

9. A pesticide concentrate as set forth in claim 8, wherein said alkyl carbonate is propylene carbonate.

10. A pesticide concentrate as set forth in claim 1, wherein said solvent is selected from the group consisting of tetrahydrofuran, dioxane, crown ethers, cyclohexanone, and cyclohexanol.

11. A pesticide concentrate as set forth in claim 1, wherein said first and second cosolvents are each multi-hydroxylated hydrocarbons containing 2-10 oxygen atoms.

12. A pesticide concentrate as set forth in claim 11, wherein said multi-hydroxylated hydrocarbons contain olefin groups.

13. A pesticide concentrate as set forth in claim 12, wherein said first and second cosolvents are linear or branched multi-hydroxylated hydrocarbons.

14. A pesticide concentrate as set forth in claim 1, wherein said first cosolvent is a C₆ to C₁₀ compound.

15. A pesticide concentrate as set forth in claim 14, wherein said first cosolvent is hexylene glycol.

16. A pesticide concentrate as set forth in claim 1, wherein said second cosolvent is a C₃ to C₄ compound.

17. A pesticide concentrate as set forth in claim 16, wherein said second cosolvent is propylene glycol.

18. A pesticide concentrate as set forth in claim 16, wherein said second cosolvent is butylene glycol.

19. A pesticide concentrate as set forth in claim 16, wherein said second cosolvent is glycerol.

20. A pesticide concentrate as set forth in claim 1, wherein said emulsifier has an HLB value of 10-14.

21. A pesticide concentrate as set forth in claim 1, wherein said emulsifier is a nonionic emulsifier.

22. A pesticide concentrate as set forth in claim 20, wherein said emulsifier is a linear alcohol C₉-C₁₄ ethoxylate having 9-30 moles of ethoxylation.

23. A pesticide concentrate as set forth in claim 20, wherein said emulsifier is an ethoxylated aryl phenol having 9-30 moles of ethoxylation.

24. A pesticide concentrate as set forth in claim 1, wherein said emulsifier has a molecular formula of C₁₄H₂₂O(C₂H₄O)n corresponding to the structure: 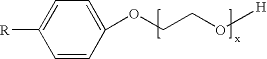
where n=2-30 and R is H or an alkyl group.

25. A pesticide concentrate as set forth in claim 1, wherein said emulsifier is selected from the group consisting of alkyl phenol ethoxylates, linear and/or branched fatty acids ethoxylates, hydrocarbon linear and/or branched alcohol ethoxylates, alkoxylated amides, alkoxylated amines, comb block polymers, and ethylene/propylene block polymers.

26. A pesticide concentrate as set forth in claim 1, wherein said Lewis acid pesticide portion is selected from the group consisting of quinclorac, 2,4-D, fenoxaprop, dikegulac, mefluidide, glyphosate, dicamba, MCPP, MCPA, MCPB, 2,4-DP, triclopyr, picloram, 2,4-DB, fluoroxypyr, aminopyralid, clopyralid, optical isomers of MCPP, MCPB, 2,4-DP, imazaquin, imazethapyr, imazapyr, MSMA, boric acid, and phosphoric acid.

27. A pesticide concentrate as set forth in claim 1, wherein said oil-soluble pesticide component is a protox inhibitor selected from the group consisting of pyraflufen-ethyl, flumiclorac-pentyl, flumioxazin, fluthiacet-methyl, aclonifen, bifenox, chlornitrophen, ethoxyfen, fluoroglycofen-ethyl, fomesafen, lactofen, oxyfluorfen, azafendin, cinidon-ethyl, oxadiargyl, oxadiazon, pentoxazone, flumipropyn, flupropacil, benzfendizone, nipyraclofen, fluazolate, thidiazimin, a triazalone, and a compound having the structural formula 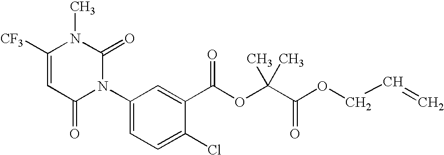
or combinations thereof.

28. A pesticide concentrate as set forth in claim 1, wherein said oil-soluble pesticide component is selected from the group consisting of dithiopyr, chlorflurenol, fenoxaprop-ethyl, fluazifop-p-butyl, azadirachtin, esters of 2,4-D, 2,4-DP, MCPP, MCPB, MCPA, triclopyr, picloram, 2,4-DB, fluoroxypyr, aminopyralid, clopyralid, and the optical isomers of MCPP, MCPB, and 2,4-DP.

29. A pesticide concentrate as set forth in claim 1, wherein said complexing agent is DEA.

30. A pesticide concentrate as set forth in claim 1, wherein said complexing agent is KOH.

31. A pesticide concentrate as set forth in claim 1, wherein said complexing agent is TEA.

32. A stable pesticide concentrate for preparation of a water-based microemulsion formulation comprising the combination on an approximate weight percent basis of:

| | |
|---|---|
| 1.6% | Dithiopyr |
| 10.7% | 2-4,D |
| 4.4% | Quinclorac |
| 1.1% | Dicamba |
| 0.5% | Pyraflufen-ethyl |
| 6.0% | Propylene Carbonate |
| 24.5% | Hexylene Glycol |
| 24.5% | Glycerol |
| 12.% | Triton X-100 |
| 14.4% | DEA. |

33. A stable pesticide concentrate for preparation of a water-based microemulsion formulation comprising the combination on an approximate weight percent basis of:

| | |
|---|---|
| 4.5% | Dithiopyr |
| 10.5% | 2-4,D |
| 5.7% | R(+) MCPP |
| 1.0% | Dicamba |
| 6.4% | Propylene Carbonate |
| 25.8% | Hexylene Glycol |
| 25.8% | Glycerol |
| 11.4% | Triton X-100 |
| 8.9% | DEA. |

34. A stable pesticide concentrate for preparation of a water-based microemulsion formulation comprising the combination on an approximate weight percent basis of:

| | |
|---|---|
| 2.7% | Chlorflurenol |
| 4.4% | R(+) MCPP |
| 9.6% | Propylene Carbonate |
| 31.6% | Hexylene Glycol |
| 31.6% | Glycerol |
| 9.6% | Triton X-100 |
| 10.4% | DEA. |

35. A stable pesticide concentrate for preparation of a water-based microemulsion formulation comprising the combination on an approximate weight percent basis of:

| | |
|---|---|
| 2.3% | Quinclorac |
| 1.2% | Dithiopyr |
| 7.9% | Propylene Carbonate |
| 31.6% | Hexylene Glycol |
| 31.6% | Glycerol |
| 15.8% | Triton X-100 |
| 9.5% | DEA. |

36. A stable pesticide concentrate for preparation of a water-based microemulsion formulation comprising the combination on an approximate weight percent basis of:

| | |
|---|---|
| 3.0% | Chlorflurenol |
| 4.4% | 2-4,D |
| 14.7% | Propylene Carbonate |
| 31.5% | Hexylene Glycol |
| 31.5% | Glycerol |
| 13.4% | Triton X-100 |
| 1.6% | DEA. |

37. A stable pesticide concentrate for preparation of a water-based microemulsion formulation comprising the combination on an approximate weight percent basis of:

| | |
|---|---|
| 2.2% | Dithiopyr |
| 0.40% | Sulfentrazone |
| 9.6% | 2-4,D |
| 0.9% | Dicamba |
| 2.0% | Quinclorac |
| 7.2% | Propylene Carbonate |
| 28.6% | Glycerol |
| 28.6% | Hexylene Glycol |
| 12.1% | Triton X-100 |
| 8.5% | DEA. |

38. A stable pesticide concentrate for preparation of a water-based microemulsion formulation comprising the combination on a weight percent basis of about:

| | |
|---|---|
| 1.6% | Fluazifop-butyl |
| 0.6% | Mefluidide |
| 17.2% | Propylene Carbonate |
| 31.5% | Propylene Glycol |
| 28.60% | Hexylene Glycol |
| 20.0% | Triton X-100 |
| 0.6% | DEA. |

39. A stable pesticide concentrate for preparation of a water-based microemulsion formulation comprising the combination on a weight percent basis of about:

| | |
|---|---|
| 2.9% | Azadirachtin |
| 2.9% | Phosphoric acid |
| 30.5% | Propylene Carbonate |
| 16.6% | Propylene Glycol |
| 27.7% | Hexylene Glycol |
| 19.4% | Triton X-100 |
| 0.03% | DEA. |

40. A pesticide formulation comprising a concentrate as set forth in claim 1, wherein is provided from about 1% to about 10% by weight of the concentrate in water of dilution.

41. A pesticide formulation comprising a concentrate as set forth in claim 1, wherein is provided from about 1% to about 4% by weight of the concentrate in water of dilution.

42. A pesticide formulation comprising a concentrate as set forth in claim 1, wherein is provided from about 2% to about 4% by weight of the concentrate in water of dilution.

43. A diluted pesticide formulation comprising a concentrate as set forth in claim 40, wherein is provided from about 1% to about 10% by weight of the concentrate in water of dilution, and that has an electrical potential from about −200 mV to about +200 mV.

44. A diluted pesticide formulation comprising a concentrate as set forth in claim 42, wherein is provided from about 2% to about 4% by weight of the concentrate in water of dilution, and that has an electrical potential from about −80 mV to about +110 mV.

45. A pesticide concentrate as set forth in claim 1, wherein a sufficient quantity of the inactive biphasic coupling agent and the complexing agent are provided to prevent precipitation and/or crystallization of the concentrate when subjected to a temperature of −15° C. for a time of at least about 12 hours.

46. A pesticide concentrate as set forth in claim 1, wherein a sufficient quantity of the inactive biphasic coupling agent and the complexing agent are provided to prevent chemical decomposition of the constituents of the concentrate when subjected to a temperature of 40° C. for at least about 30 days.

47. A pesticide concentrate as set forth in claim 1, wherein a sufficient quantity of the inactive biphasic coupling agent and the complexing agent are provided to prevent chemical decomposition of the constituents of the concentrate when subjected to a temperature of 25° C. for at least about two and one-half months.
